(19) United States
(12) Patent Application Publication
(10) Pub. No.: US 2014/0279296 A1
(43) Pub. Date: Sep. 18, 2014

(54) REFERRED SALE SYSTEM

(71) Applicant: Verance Corporation, San Diego, CA (US)

(72) Inventors: Rade Petrovic, San Diego, CA (US); Joseph M. Winograd, San Diego, CA (US); Jian Zhao, San Diego, CA (US); Dean Angelico, San Diego, CA (US)

(73) Assignee: VERANCE CORPORATION, San Diego, CA (US)

(21) Appl. No.: 14/213,365

(22) Filed: Mar. 14, 2014

Related U.S. Application Data
(60) Provisional application No. 61/800,699, filed on Mar. 15, 2013.

(51) Int. Cl. G06Q 30/00; G06Q 10/08

(52) U.S. Cl. CPC G06Q 30/0185; G06Q 10/087
USPC 705/28; 705/318

(57) ABSTRACT

Methods, devices, systems and computer program products use watermarks to allow a user to explore to obtain desired content and related items. One device includes an extended payload (EP) watermark extractor coupled to an audio input and to an enhanced response coordinator (ERC). The device also includes a copy control information (CCI) watermark detector coupled to the audio input and coupled to a copy management compliance logic component. The ERC is further coupled to the EP extractor and to a communication component. The device also includes a referred sale logic component coupled to the ERC to receive referral information that is indicative of one or more alternative options. The device further includes a digital service provider (DSP) client component coupled to the referred sale logic and also coupled to the communication component that allows the DSP client to communicate with DSPs and to receive one of the alternative options.

### CROSS REFERENCE TO RELATED APPLICATIONS

This patent application claims the benefit of U.S. Provisional Patent Application No. 61/800,699, filed Mar. 15, 2013. The entire content of the before-mentioned provisional patent application is incorporated by reference as part of the disclosure of this application.

### FIELD OF INVENTION

The present application generally relates to the field of content management. More particularly, the disclosed embodiments relate to facilitating access to a content or alternative options when the content is subject to copy control enforcement policies.

### BACKGROUND

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A multimedia content, such as an audiovisual content, often consists of a series of related images which, when shown in succession, impart an impression of motion, together with accompanying sounds, if any. Such a content can be accessed from various sources including local storage such as hard drives or optical disks, remote storage such as Internet sites or cable/satellite distribution servers, over-the-air broadcast channels, etc. In some scenarios, such a multimedia content, or portions thereof, may contain only one type of content, including, but not limited to, a still image, a video sequence and an audio clip, while in other scenarios, the multimedia content, or portions thereof, may contain two or more types of content.

Watermarking has been used to enable the communication and enactment of use policies for multimedia content across a broad range of distribution channels and devices. Watermarks are typically embedded substantially imperceptibly in one or more components of a multimedia content, such as in an audio component or a video component, and can be used for a variety of applications such as tamper detection, copy management, content identification, broadcast monitoring, etc.

### SUMMARY

The disclosed embodiments relate to the use of watermarks that are embedded in a host content to facilitate content access, and to enhance a user's experience by allowing the user to explore additional options for obtaining the desired content and related items of interest.

One aspect of the disclosed embodiments relates to a method that includes receiving an indication for an access to a content that includes one or more copy management watermarks and one or more enhanced payload watermarks, and extracting at least one copy management watermark and at least one enhanced payload watermark. The method also includes, upon a determination, based on the at least one copy management watermark, that access rights to the content is restricted, using the at least one enhanced payload watermark to present one or more alternative options.

In one exemplary embodiment, the above method also includes, upon the determination that access rights to the content is restricted, communicating the at least one copy management watermark and the at least one enhanced payload watermark to a database, and receiving referral information from the database comprising data indicative of an availability and a location of the one or more alternative options. In another exemplary embodiment, the method further includes presenting at least a portion of the referral information, and, upon receiving a selection request for one of the one or more alternative options, permitting access to retrieve additional information regarding the selected alternative option. According to another exemplary embodiment, permitting access to retrieve additional information comprises directing a user to a digital service provider.

In another exemplary embodiment, the digital service provider communicates a product inventory report to the database. In yet another exemplary embodiment, the digital service provider communicates a referral activity report to the database. In another exemplary embodiment, the database processes a content identifier to identify the content and one or more of a content owner or content rights. In still another exemplary embodiment, the one or more alternative options include at least one of: buying a movie ticket, viewing a similar content, accessing the content upon purchase of the content, viewing one or more advertisements, viewing an abbreviated version of the content, viewing a modified version of the content with inferior perceptible quality, or gaining access to the content by paying a subscription fee to a service.

In one exemplary embodiment, the above method also includes performing one of the following: (a) upon a determination that a customer or a customer device is authorized to access the content, allowing presentation of the content, or (b) upon a determination that the content is a pirated content, interfering with unauthorized access to the content. In another exemplary embodiment, interfering with unauthorized access to the content includes muting an audio portion of the content. In still another exemplary embodiment, a content identifier is transmitted to a database before an enforcement action is commenced.

Another aspect of the disclosed embodiment relates to a media handling device that includes a watermark detector configured to detect at least one enhanced payload watermark from a content, and an enhanced response coordinator configured to communicate information obtained from the at least one enhanced watermark to a database, and to receive referral information from the database. The media handling device also includes a referred sale logic component configured to allow presentation of at least a portion of the referral information indicative of one or more alternative options when access to the content is restricted based on information ascertained from at least one copy control watermark embedded in the content. The referred sale logic component is also configured to allow access to retrieve additional information regarding a selected alternative option of the one or more alternative options.

In one exemplary embodiment, the media handling device further includes a digital service provider client component. In another exemplary embodiment, the media handling device also includes a media player component. In still another exemplary embodiment, the media handling device includes a player control subsection and a player presentation engine subsection, where the referred sale logic component is implemented as part of the player control subsection, and the watermark detector is implemented as part of the player presentation engine subsection. In another exemplary embodiment, the watermark detector is coupled to an audio input to screen an audio portion of the content.

In another exemplary embodiment, a system includes the above noted media handling device. Such a system also includes the database configured to communicate with the media handling device, and a digital service provider device configured to communicate with media handling device and to provide the contents of the one or more alternative options. In one exemplary embodiment, the digital service provider device is further configured to communicate a product inventory report to the database. In another exemplary embodiment, the digital service provider is further configured to communicate a referral activity report to the database.

Another aspect of the disclosed embodiments relates to a computer program product, embodied on one or more non-transitory computer readable media. The computer program product includes program code for receiving an indication for an access to a content that includes one or more copy management watermarks and one or more enhanced payload watermarks, program code for extracting at least one copy management watermark and at least one enhanced payload watermark, and program code for, upon a determination, based on the at least one copy management watermark, that access rights to the content is restricted, using the at least one enhanced payload watermark to present one or more alternative options.

Another aspect of the disclosed embodiments relates to a media handling device that includes an extended payload watermark extractor coupled to an audio input, where the audio input provides digital samples representing an audio portion of a content, and the extended payload watermark extractor is further coupled to an enhanced response coordinator (ERC). The media handling device also includes a copy control information (CCI) watermark detector coupled to the audio input, where the CCI watermark detector is further coupled to a copy management compliance logic component that determines, based on extracted CCI watermark values provided to the copy management compliance logic component, whether or not access rights to the content is restricted. The ERC is coupled to the extended payload extractor to receive extended payload information from the extended payload extractor, and the is ERC further coupled to a communication component that allows the ERC to communicate with one or more databases. The media handling device also includes a referred sale logic component that is coupled to the ERC to receive referral information from the ERC, where the referral information is indicative of one or more alternative options associated with the content having restricted access rights. The media handling device also includes a digital service provider (DSP) client component that is coupled to the referred sale logic to receive a request for the at least one of the one or more alternative options. Such a request is provided by the referred sales logic to the DSP client component, and the DSP client component is further coupled to the communication component that allows the DSP client to communicate with one or more digital service providers and to receive the at least one of the one or more alternative options.

In one exemplary embodiment, the media handling device further includes a display, and an output control component that is coupled to the display to control audio or video presentation capabilities of the display. In another exemplary embodiment, the referred sale logic component is coupled to the output control module to enable presentation of the at least one of the one or more alternative options on the display. In another exemplary embodiment, the extended payload information includes an extended payload event and an extended payload record, the extended payload event representing a detection of an expended payload value from the audio portion that satisfies predefined conditions and the extended payload record including a list of one or more extended payload values that contributed to the extended payload event.

In one exemplary embodiment, the media handling device includes a player control subsection, and a player presentation engine subsection, where the referred sale logic component and the copy management compliance logic component are implemented as part of the player control subsection, and the extended payload watermark extractor and the CCI watermark extractor are implemented as part of the player presentation engine subsection. In yet another exemplary embodiment, the ERC is implemented as part of the player presentation engine subsection. In still another exemplary embodiment, the ERC includes an output to control muting of an audio output of the media handling.

Another exemplary embodiment relates to a system that includes the above noted media handling device. Such a system also includes the one or more digital service providers (DSPs) and the one or more databases. Each of at least one of the one or more DSPs is coupled to the one or more databases to transmit information regarding referred sale activities and inventory to the one or more databases. In another exemplary embodiment, the one or more databases are located at different geographical locations.

Another aspect of the disclosed embodiments relates to a method for facilitating usage of a content handling device. The method includes extracting at least one copy control watermark using a copy control information (CCI) watermark detector from an audio portion of a content, where the at least one copy control watermark indicates that access rights to the content is restricted. The method also includes using an extended payload watermark extractor to extract at least one extended payload watermark from the content and to generate extended payload information, and communicating the extended payload information to an enhanced response coordinator component of the media handling device for subsequent transmission to one or more databases. The method additionally includes receiving from the one or more databases referral information regarding one or more alternative options or supplements to the content having restricted access rights at the enhanced response coordinator component, communicating the referral information to a referred sale logic component of the media handling device, and presenting an indication of availability of the one or more alternative options or supplements on a user interface. The method further includes receiving a request indicative of a selection of the one or more presented alternative options or supplements, communicating the request to a digital service provider client component of the media handling device for transmission to one or more digital service providers, and receiving the one or more alternative options from the one or more digital service providers.

In one exemplary embodiment, the above method further includes presenting the one or more alternative options using the media handling device. In another exemplary embodiment, the extended payload information includes (a) an extended payload event, where the extended payload event representing a detection of an expended payload value from the content that satisfies predefined conditions, and (b) an extended payload record, the extended payload record including one or more extended payload values that contributed to the extended payload event.

In another exemplary embodiment, the above method further includes transmitting information regarding referred sale activities or inventory from the one or more DSPs to the one or more databases. In yet another exemplary embodiment, the information regarding referred sale activities or inventory includes one or both of (a) a product inventory report indicative of available products and services at the one or more DSPs, or (b) a referral activity report indicative of the referral activities that have occurred at the one or more DSPs during a period of time. In still another exemplary embodiment, a content identifier is transmitted to the one or more databases prior to a determination that an enforcement action is needed to restrict the use of the content. In one exemplary embodiment, processing a content identifier to identify the content and one or more of a content owner or content rights.

Another aspect of the disclosed embodiments relates to a computer program product, embodied on one or more non-transitory computer readable media. The computer program product includes program code for extracting at least one copy control watermark using a copy control information (CCI) watermark detector from an audio portion of a content, where the at least one copy control watermark indicates that access rights to the content is restricted. The computer program product also includes program code for using an extended payload watermark extractor to extract at least one extended payload watermark from the content and to generate extended payload information, and program code for communicating the extended payload information to an enhanced response coordinator component of the media handling device for subsequent transmission to one or more databases. The computer program product further includes program code for receiving from the one or more databases referral information regarding one or more alternative options associated with the content having restricted access rights at the enhanced response coordinator component, and program code for communicating the referral information to a referred sale logic component of the media handling device. The computer program product additionally includes program code for presenting an indication of availability of the one or more alternative options on a user interface, program code for receiving a request indicative of a selection of the one or more presented alternative options, program code for communicating the request to a digital service provider client component of the media handling device for transmission to one or more digital service providers; and program code for receiving the one or more alternative options from the one or more digital service providers.

### BRIEF DESCRIPTION OF THE DRAWINGS

FIG. 1 is a high level diagram a watermark detection system for enabling provision of recommendations to a user.

FIG. 2 is a diagram of the overall functionality and flow associated with an enhanced response in accordance with an exemplary embodiment.

FIG. 3 is a screen shot of an example enforcement action in response to the detection of an embedded watermark.

FIG. 4 is a diagram of a system, as well as the flow chart of operations that can be conducted, that enable enhanced media consumption in accordance with an exemplary embodiment.

FIG. 5 is a diagram illustrating communications between a database and a Digital Service Provider in accordance with an exemplary embodiment.

FIG. 6 is a system diagram illustrating different components that enable enhanced media consumption in accordance with an exemplary embodiment.

FIG. 7 is a block diagram illustrating input-output configurations of a Watermark Detector in accordance with an exemplary embodiment.

FIG. 8 is a block diagram illustrating input-output configurations of an Enhanced Response Coordinator in accordance with an exemplary embodiment.

FIG. 9 is a block diagram illustrating input-output configurations of an Enhanced Referred Sale Logic in accordance with an exemplary embodiment.

FIG. 10 illustrates a block diagram of a device within which at least some of disclosed embodiments may be implemented.

FIG. 11 illustrates a set of exemplary operations that may be carried out to enable enhanced access to a content in accordance to an exemplary embodiment.

FIG. 12 illustrates a set of exemplary operations to allow enhanced access to a content in accordance to an exemplary embodiment.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

U.S. patent application with Ser. No. 13/324,421 (“'421 application”, titled “Conditional Access Using Embedded Watermarks,” filed on Dec. 13, 2011, and assigned to the assignee of the present application, is incorporated by reference in its entirety.

In some applications, the auxiliary information that is hidden within the host content is used to provide copy control for the host media content. For example, the detection of an embedded watermark that includes copy control information (CCI) (referred to as a CCI watermark) may stop the playback of an unauthorized content. In other applications, digital watermarks may be used to carry other information, such as the identity of the content itself, the content owner, the distribution channel, the content format, and the like. Typically such information is embedded into the content using watermarks that have a larger payload (referred to as an Extended Payload (EP) watermark, or alternatively an Enhanced Payload watermark) than the CCI watermarks. For example, while a watermark payload of 8 bits may suffice for carrying CCI, an extended payload of, for example, 20 to 100 bits may be required to embed non-copy control information. In some applications, EP watermarks may have different performance and reliability requirements than CCI watermarks. In some implementations, an extended payload contains information that not only identify a content in which such extended payload embedded, but also a timecode that indicates the current position in the timeline of the content.

The embodiments of the present application relate to methods, systems, devices and computer program products that enhance consumption of a multimedia content that leverages the detection of embedded watermarks to facilitate a user's access to the content, and/or to provide additional goods and services. For example, in response to an enforcement action triggered due to detection of a CCI watermark (sometimes also referred to as a Copy Management Payload or Copy Management Watermark) from a content, an offer to sell that content or to provide additional content can be provided.

FIG. 1 provides a high level description of a watermark detection system in which the extracted watermarks can be used to enable provision of recommendations on subsequent user and/or device actions, offers to purchase authorized copies of the content that is being played, and the like. The watermark extraction components 102 are responsible for extracting various watermark messages that are embedded within a content, such as CCI and EP watermarks. FIG. 1 does not depict the individual components within the watermark extraction components 102. It is understood, however, that the watermark extraction components 102 can comprise several components that assist in processing of a content to extract the embedded watermarks. The watermark extraction components 102 may further be part of a larger device or system, such as a portable consumer device, and/or may be implemented in hardware, software and/or combinations thereof. The watermark extraction components 102 may also be part of a distributed system, where part of the extraction process is carried out at a remote device, such as a remote server.

The watermark extraction components 102 provide extraction results, such as the CCI and EP watermark values, user and device information, and other information, to the content and advertisement provision components 106 through the communication channel 114. The communication channel 114 may comprise wired or wireless communication channels. The content and advertisement provision components 106, in return, provide the watermark extraction components 102 with information such as metadata related to the content with embedded watermarks, recommendations on subsequent user and/or device actions, offers to purchase authorized copies of the content that is being played, referrals to other sources of content, targeted and/or contextual advertising, and other information. The content and advertisement provision components 106 may include one or more servers, general computing devices and/or specific devices and the associated software that are configured to receive and process information and commands from the watermark extraction components 102 and provide the appropriate response.

FIG. 1 also depicts the collection and analysis components 104 that are in communication with the watermark extraction components 102 through the communication channel 110. The collection and analysis components 104 collect and analyze usage behaviors associated with the watermark extraction components 102. The collection and analysis components 104 can further analyze consumption patterns, consumer behavior and business and market intelligence. The collection and analysis components 104 can comprise a plurality of servers, as well as hardware and/or software components that can be configured to perform the required collection and analysis. The watermark extraction components 102 may also be in communication with the transaction fulfillment components 108 through the communication channel 112. The transaction fulfillment components 108 conduct operations such as authentication, negotiation, payments, product delivery, and other operations that are needed to complete a transaction with the watermark extraction components 102 (or the device that incorporates the watermark extraction components 102). It should be noted that any one of the described components may be part of a larger device or system, such as a portable consumer device, and/or may be implemented in hardware, software and/or combinations thereof.

The following systems and devices are used in connection with the description of some of the disclosed embodiments: “Extended Payload Extractor” (also known as the Watermark Aggregation Record Generator), the “Referred Sale Logic” and the “Enhanced Response Coordinator.” In some embodiments the term “enhanced watermark” is used to identify those watermarks, or payload portion of a larger watermark, the detection of which enables the provision of additional goods and services to a user.

The embodiments of the present application further address the larger issue of converting pirates into consumers. Such conversion in behavior is encouraged at least in-part since certain offers, choices and options are presented to a user at the moment when the user is ready to watch a movie, but receives an enforcement message. The offers, choices and options can include, for example, offering the user the option of purchasing the content or other products.

In some systems, the content that is received by a content handling device (e.g., at user premises) examines the content to determine if the content includes a CCI watermark and/or a content identifier (CID) (in some scenarios the CID can be obtained using sources other than the embedded watermarks). In such systems, since a CID can be sent from the content handling device to a database (e.g., a ConfirMedia database), before, and regardless of the enforcement of the CCI watermark, the database can provide useful information back to the content handling device. This information may include driving a recommendation engine that provides suggestions as to what to watch next, offers of the availability of similar products (e.g. higher res versions, newer versions, etc.), and/or other actions.

FIG. 2 is a diagram of the overall functionality and flow associated with an enhanced response in accordance with an exemplary embodiment. The operations in FIG. 2 are primarily focused on the embedding and detection of EP watermarks. As noted earlier, it is understood that the produced contents also includes CCI watermarks, the presence and detection of which can trigger an enforcement action. The content production facility of FIG. 2 includes an enhanced watermark embedder 202 that embeds an EP watermark, that includes, e.g., a CID value. Upon distribution, and perhaps piracy of the content through a content distribution channel 204 (e.g., the Internet), a consumer device that is equipped with an enhanced watermark detector 206, can extract the EP watermark and apply the associated rules using an enhanced Rule Application component 208 to provide additional options (e.g., alternatives and/or supplements) to the user. If the content that is received at the consumer device is a legitimate content (e.g., the consumer device and/or the consumer has authorization to view the content), the content may be presented as normal on the presentation device 210, such as a television. However, the detection of EP watermarks can further allow the user to have access to additional contents and services. If the content that is received at the consumer device is a pirated content, the detection of CCI watermarks is bound to stop the playback and/or interfere with unauthorized access of the content. However, due to the presence and detection of the EP watermarks, the consumer can be provided with one or more options for legitimately acquiring a right to consume the content and/or an affiliated content or service.

As illustrated in FIG. 2, the actions that are triggered in response to the detection of watermarks are categorized as defensive responses, such as stopping the playback of the content, muting the audio, etc. Enhanced responses, on the other hand, leverage a user/market demand and provide an offering to satisfy that demand. Defensive responses are expected to provide a strong deterrence of unauthorized content access, increase frustration of the pirates, and drive secondary monetization opportunities. The enhanced responses as expected to produce a higher conversion of pirates to legitimate content users, allow a timely response at the peak moment of user's interest in the content, and enable direct monetization in exchange for the provision of additional contents and services.

FIG. 3 is a screen shot of an example enforcement action (i.e., muting of the audio) in response to the detection of an embedded watermark that restricts the use of the content. FIG. 3 further shows a portion of the screen that allows the user to select other options (e.g., based on a presented offer, or click on a message that informs the user that other options, such are retrieval of the content from an alternate site, are available).

As evident from the illustrations in FIGS. 2 and 3, the systems and methods of the present application provide various benefits in that they offer consumers an option to watch a content from a legitimate source and at the peak of their interest. Therefore, it is expected that such a system and service to have a high conversion rate of would-be-pirates to loyal customers.

FIG. 4 is a diagram of a system, as well as the flow chart of operations that can be conducted, that enable enhanced media consumption in accordance with an exemplary embodiment. FIG. 4 illustrates the communications between a database, such as the Confirmedia Web Services 402 database, a Consumer Electronic (CE) Product 404, and a Digital Service Provider (DSP) 414. In the operation labeled as 1, an Enhanced Detector 406 reports the detected Copy Management Payload and the obtained CID value to a Blu-ray Disc (BD)/Video Player Application 410 that is integrated with an Enhanced Response Coordinator (ERC) 408. At operation 2, the integrated BD Player Application 410/ERC 408 transmits the CID to the database that is part of the ConfirMedia Web Services 402. At operation 3, the ConfirMedia Web Services 402 transmits Referral Information (e.g., Digital Service Provider (DSP) Stock Keeping Units (SKUs)) to the Player Application 410 for presentation to the user. At operation 4, if the user accepts the referral provided by the referral information, the BD Player Application 410 launches the Digital Service Provider (DSP) Client 412 with referral information. At operation 5, the DSP Client 412 presents purchase offer or other options to the user.

FIG. 5 is a diagram illustrating communications between the database at the Confirmedia Web Services 402 and the Digital Service Provider 414 in accordance with an exemplary embodiment. The operations that are depicted in FIG. 5 can occur in the background. In operation 1, the DSP 414 provides Product Inventory Reports to the ConfirMedia Web Services 402 periodically (e.g., weekly or as title inventory changes). For example, a Product Inventory Report can indicate the available products and services at the DSPs. At operation 2, the DSP provides Referral Activity Reports to the ConfirMedia Web Services 402 periodically (e.g., on a monthly basis). For example, a Referral Activity Report can indicate the referral activities that have occurred at the DSPs during a period of time. For instance, such a referral activity report can indicate how many referrals resulted in consumers requesting web pages or other information from the DSP, how many referrals resulted in consumers purchasing content from the DSP, how many referrals came from consumers that already had (or did not have) accounts with the DSP, or of those that did not have accounts, how many chose to open an account with the DSP upon referral. In addition, the referral activity reports can include the number of new account sign-ups and other activities such as pre-order, watching trailers, and purchase of other content, as well as anonymous statistic information about these activities such as (a) when each activity took place in which countries or what content is associated with such activity. These reports can also include information about the delivery method of the purchased content (streaming, download, physical media).

The following provides additional details regarding the components that are illustrated in FIGS. 4 and 5.

Enhanced Detector: In one exemplary embodiment, the enhanced detector 406 can be implemented as a software library that screens audio and reports CCI and CID watermarks. In some embodiments, the enhanced detector 406 can be fully or partially implemented in hardware, software and/or firmware.

BD/Video Player Application: In one exemplary embodiment, the BDNideo Player Application 410 can be implemented as a built-in application in the CE product 404. The BDNideo Player Application 410 can be used by consumers to play movies. The BDNideo Player Application 410, or portion thereof, implements copy control enforcement logic that is based on, at least in-part, the detected CCI watermarks. The BDNideo Player Application 410 is further configured to present referrals. In one embodiment, the BDNideo Player Application 410 is integrated with the Enhanced Response Coordinator (ERC) 408. In some embodiments, the BDNideo Player Application 410 can be fully or partially implemented in hardware, software and/or firmware.

Enhanced Response Coordinator (ERC): In one exemplary embodiment, the ERC 408 is implemented as a software library to be integrated with BD Player Application 410. The ERC 408 implements protocols with ConfirMedia Web Services 402 and relies on CE Product 404 network services (see also FIG. 6). In some embodiments, the ERC 408 can be fully or partially implemented in hardware, software and/or firmware.

Digital Service Provider (DSP) Client: In one exemplary embodiment, the DSP Client 412 is implemented as an application that is built-in to the CE Product 404, and allows consumers to access the DSP 412. The DSP Client 412 is configured to accept and process referrals from the BDNideo Player Application 410 and present them to the DSP 412. In some embodiments, the DSP Client 412 is a component that can be fully or partially implemented in hardware, software and/or firmware.

ConfirMedia web services: ConfirMedia Web Services 402 is an exemplary web service that is developed and operated 24/7 by Verance Corporation. It should be noted that other web services with similar capabilities and services can be used. As part of its operations. ConfirMedia Web Services 402 processes the CIDs that are received from CE Products 404 to identify the content and associated information (e.g., content owner, content rights, etc.). ConfirMedia Web Services 402 also imports product inventory and referral activity reports from the DSP 414 and provides a user interface (UI)/Application Programming Interface (API), as well as the underlying operational capabilities, to allow content registration and administration. In some exemplary embodiments, ConfirMedia Web Services 402 implements ConfirMedia Web Services Web Services 402 protocols using HTTPs and Representational State Transfer (REST) based architecture. ConfirMedia Web Services 402 is also scaled to meet worldwide market penetration of CE Products 404 and the implemented protocols enable peak smoothing by pre-fetching the CID values. In some exemplary embodiments, the operations of the ConfirMedia Web Services 402 are distribute geographically to improve latency.

Digital Service Provider (DSP) (also referred to as “DSP web services”): Digital Service Provider web services 414 are developed and operated 24/7 by an online content distributor. DSP web services 414 can include a large-scale e-commerce site that is enhanced to allow processing of referrals that are communicated from DSP Clients 412. DSP web services 414 can also collect and maintain referral information, export referral activity reports, and export product inventory reports to, for example, the ConfirMedia Web Services 402. The referral activity reports can, for example, include one or more of the number of referrals, purchases, new account sign-ups or other information. The product inventory reports can, for example, include one or more of sufficient title information to allow content/title to be registered, as well as availability timing of the content, or SKU data for purchase transaction from the CE Product 404.

FIG. 6 is a system diagram illustrating different components that enable enhanced media consumption in accordance with an exemplary embodiment. Some, or parts, of the corresponding components that were presented in FIG. 4 are shown as highlighted blocks in FIG. 6. FIG. 6 also illustrates, at a very high level, communication paths among the components, as well as the locations of various components. In particular, the player presentation engine 606 includes several components such as the extended payload extractor 616 which is part of the enhanced detector 406 of FIG. 4. The audio portion of the content received at the player presentation engine 606 is delivered to the enhanced payload extractor 616 and to a CCI watermark extractor, such as the Cinavia detector 610, where the enhanced watermark payload and the CCI payload, respectively, are extracted. Watermark extraction results (e.g., raw detection results, aggregated results, detection events, etc.) are communicated to a copy management compliance logic component, such as the Cinavia Compliance Logic 614, which can trigger enforcement actions (e.g., muting of audio, or stopping of playback) take place.

EP watermarks that include the CIDs are extracted by the extended payload extractor 616. The extraction results (e.g., raw detection results, aggregated results, detection events, etc.) are communicated to the Enhanced Response Coordinator (ERC) 408, where subsequently transmitted to the ConfirMedia Content ID Service 618 using a communication component through the player's network services. The ConfirMedia Content ID Service 618 is part of the ConfirMedia Web Services 402 that is depicted in FIG. 4. The ERC 408 can also provide referral information (e.g., DSP's SKU information, etc.) that it receives from the ConfirMedia ID Service 618 to the Referred Sale Logic component 608. The user can then formulate a request by, for example, selecting one or more of the presented options (e.g., to purchase a related content). The selection or request received from the user interface (UI) control 622 causes the DSP Application 620 to request the selected items from one or more DSPs 414. The DSP Application 620 can be part of the DSP client 412 component that is depicted in FIGS. 4 and 5.

The architecture presented in FIG. 6 provides several advantages and benefits. In particular, separating the various components within the media handling device enhances the security and renewability of the components. For example, the extended payload extractor 616 and the Cinavia Detector 610 are integrated directly as part of the player presentation engine 606, which makes it more difficult for a pirate to infiltrate these components, to modify their operation, and to circumvent the enforcement actions mandated by the CCI watermarks. The presence of the ERC 408 and the associated API as a separate component allows modular implementation of a central coordinator that operates as a central command module for receiving information from the internal components of the media handling device and communicating with the databases and entities that are outside of the media handling device. Further, the separation of the ERC 408 from the EP Extractor 616 allows for different companies in the development/supply chain to implement different pieces of the system. A separate and central ERC 408 can further allow the coordination of communications with multiple EP extractors 616 within a single product, if multiple EP extractors 616 were needed. As noted earlier, the ERC in some embodiments may be integrated into the player presentation engine 606, but its functionality may kept separate from the remaining components of player presentation engine 606.

Additionally, the implementation of the referred sale logic 608 and the CCI compliance logic 614 as part of the player control/navigation manager 604 allows the implemented compliance rules and sale logic to be readily updated if such a need arises. Finally, the implementation of the DSP client component 620 outside of the player control/navigation manager 604 and the player presentation engine 606 allows the implementation or removal of various client applications from multiple vendors without affecting the operations or architecture of the remaining components.

FIG. 7 is a block diagram illustrating input-output configurations of a Watermark Detector in accordance with an exemplary embodiment. For example, the Watermark Detector of FIG. 7 can include both the Extended Payload Extractor 616 and the Cinavia CCI Detector 610 of FIG. 6. The inputs to the Watermark Detector in FIG. 7 are categorized based on their activities (1) during initialization (2) during run time, or (3) during both initialization and runtime.

The inputs to the Watermark Detector of FIG. 7 that are provided upon initialization include the Duty Cycle input which configures the Watermark Detector to operate continuously or in an intermittent detection mode based on a specified duty cycle. The Enforcement Logic Selection input allows one of the primary or the secondary enforcement logic to be selected (e.g., the primary logic may present a more strict enforcement action relative to the secondary logic). The Random Seed input provides a random seed for use by the Watermark Detector, and the Callback Registrations input registers callbacks. A callback is an example of an event-driven interruption that allows the Watermark Detector to invoke the ERC when one or more extended payloads that satisfy certain conditions are obtained. One benefit of the callback is to signal that a message is ready for another module/layer to process without pausing the sender of the message. In one example where the Watermark Detector and the ERC are implemented in software, the Detector can “call back” into the ERC, and the ERC just queues it for later processing. That way, the player presentation engine does not have to wait for the entire message to the ERC to be processed. Callback registration may also be considered as the process of an upper layer (e.g., the control layer where the ERC is running) instructing the Watermark Detector (e.g., in the lower layer—presentation engine) how to notify that upper layer ERC if/when the Detector (presentation engine) needs to send it a message.

The inputs that can be provided either upon Watermark Detector initialization or at run time include Enforceable Payloads List, EP Detection On/Off, and Audio Format Information. The EP Detection On/Off can be generated by the Enhanced Response Coordinator (see also FIG. 8). The inputs to the Watermark Detector that are only provided at runtime include the Audio input that delivers the audio portion of the content to the Watermark Detector, and the Enforcement Logic State input. The Enforcement Logic State provides information about the current enforcement status and can include, but is not limited to, grace period timers (a grace period is a period of time that content access is permitted before an enforcement action is commenced), detection counters (e.g., counts of how many watermarks are detected within one of more time intervals), and watermark detection history.

Referring again to FIG. 7, Watermark Detector outputs include Enforcement Events, EP Events, EP Record, Get Enforcement Logic State, Channel Selection, and Detector Enable. An EP Event is an occurrence resulting from detection of Expended Payload(s) and satisfaction of other conditions. In one example, an EP event is triggered only if the detected CCI watermarks are enforceable in the particular content. This way. EP detections from a content that is protected using allowed trusted source technologies will not trigger EP event. An EP Record is a list of Extended Payloads whose detection contributed to the occurrence of an EP Event. The output labeled “Get enforcement logic state” represents a request to another device to provide detector status data from the previous detector run. The “Channel Selection” output provides information regarding which channels in, e.g., a multichannel audio content, are chosen by the Watermark Detector to attempt watermark extraction. The “Detector Enable” output is information provided that indicates if the Watermark Detector wants to be inactive in order to, for example, save processing cycles or active to perform screening.

FIG. 8 is a block diagram illustrating input-output configurations of an Enhanced Response Coordinator (ERC) in accordance with an exemplary embodiment. The ERC inputs are categorized based on their activities (1) during initialization (2) during run time, or (3) during both initialization and runtime.

The optional Get Device Information input is set when ERC is initialized and can provide information such as the device model and software version that is running on the device. The Callback Registrations input is provided upon ERC initialization. Source Control and Referred Sale Logic State inputs can be provided as part of ERC initialization or at runtime. The Source Control input provides preferences/parameter, as defined in Referred Sale Logic State, inputted by, for example, a user on a user interface at runtime. The Referred Sale Logic State input is stored in persistent storage and loaded by ERC. The Referred Sale Logic State provides the preference/parameters that are stored in persistent storage for referral sales such as (1) whether Referred Sale is enabled; (2) network settings for referral sales (e.g., HTTP proxy configurations, CIDS server timeout); (3) language and region settings for referred sales; (4) maximum number of referred sales offers will be presented; and (5) preferred content service/distribution providers for fulfillment of referred sales. The Referred Sale Logic State is generated by the Enhanced Referred Sale Logic and is provided to the Referred Sale Logic (see also FIG. 9). The EP Record and EP Events are two inputs that are provided only during runtime. These inputs are provided by the Watermark Detector (see also FIG. 7).

Referring again to FIG. 8, the outputs of the ERC include an EP Detection on/off, which turns the Extended Payload Extractor on or off. The Product Identifier (PID) Record and PID Events are two additional outputs that are provided to the Referred Sale Logic (see also FIG. 9). A PID is a unique identifier for each distinct product or service that is provided by a DSP. The PID record describes the products for referred sales offered by DSPs, which may include DSP name, SKUs or URIs, product name and logo, price and referral codes provided by the DSPs to identify the source of the referral sale. The PID event is an event that is reported by ERC to Referred Sale Logic component when one or more referred sale offers are available to be presented to the user (or called Offer Presentation event). Note that EP Event is an event from Watermark Detector to the ERC.

FIG. 9 is a block diagram illustrating input-output configurations of an Enhanced Referred Sale Logic in accordance with an exemplary embodiment. The Enhanced Referred Sale Logic of FIG. 9 can be part of the Referred Sale Logic 608 of FIG. 6. The inputs to the Enhanced Referred Sale Logic include the PID Record and PID Events that are received from the ERC upon ERC initialization. Enforcement Logic State is another input that is received from the Cinavia Compliance Logic at either initialization or at run time. EP Record and EP Event are two additional inputs that are received from the Extended Payload Extractor only during run time.

Referring again to FIG. 9, the outputs of the Enhanced Referred Sale Logic include the PID Record that is provided to the DSPs, as well as the Referred Sale Logic State that is provided to the Cinavia Compliance Logic. The Enhanced Referred Sale Logic also includes an Audio Mute on/off output, which indicates whether or not the audio is to be muted.

As described previously, the extended payloads may include timecodes. Such timecode can enable a user to continue viewing the content purchased by referrals from the position of the content where restriction took place. In some implementations, the offers are presented not only in text, graphics, but also machine readable codes such as QR/barcode to facilitate wide applications such as mobile referral. Offers may also contain promotion information for all products or specific product from a specific DSP, or a products related to a specific title across multiple DSPs. Further, offers can be provided based on the language, country of device settings, or based on the geo-location determined by device's IP address. The sound tracks of a content in different languages may also be provided to the user based on device's language settings.

As noted earlier, the components or modules that are described in connection with the disclosed embodiments can be implemented as hardware, software, or combinations thereof. For example, a hardware implementation can include discrete analog and/or digital components that are, for example, integrated on a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor that is a specialized microprocessor with an architecture optimized for the operational needs of digital signal processing associated with the disclosed functionalities.

Certain aspects of the disclosed embodiments can be implemented as a device that includes a processor, and a memory comprising processor executable code. The processor executable code, when executed by the processor, configures the device to perform any one of and/or all operations that are described in the present application. For example, FIG. 10 illustrates a block diagram of a device 1000 within which various disclosed embodiments may be implemented. The device 1000 comprises at least one processor 1004 and/or controller, at least one memory 1002 unit that is in communication with the processor 1004, and at least one communication unit 1006 that enables the exchange of data and information, directly or indirectly, through the communication link 1008 with other entities, devices, databases and networks. The communication unit 1006 may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The exemplary device 1000 of FIG. 10 can be incorporated as part of a consumer device and/or a device that resides at a database that enables web services.

It should be noted that the simplified diagrams of FIGS. 1 and 3-10 are provided to facilitate the understanding of the disclosed embodiments. As such, the arrangement of physical signals may be different in physical devices that are implemented in accordance with the disclosed embodiments.

FIG. 11 illustrates a set of exemplary operations that may be carried out to enable enhanced access to a content in accordance to an exemplary embodiment. At 1102, an indication for an access to a content is received that includes one or more copy management watermarks and one or more enhanced watermarks. For example, such an indication may be triggered when a media handing device is trying to play a content. At 1104, at least one copy management watermark and at least one enhanced watermark is extracted from the content. At 1106, upon a determination, based on the at least one copy management watermark, that access rights to the content is restricted, the at least one enhanced watermark is used to present one or more alternative options. For example, the one or more alternatives include at least one of: buying a movie ticket, viewing similar content (e.g., a content with a similar subject matter), viewing a different content, accessing the content upon purchase of the content, viewing one or more advertisements, viewing an abbreviated version of the content, viewing a modified version of the content with inferior perceptible quality, or gaining access to the content by paying a subscription fee to a service.

FIG. 12 illustrates a set of exemplary operations to allow enhanced access to a content in accordance to an exemplary embodiment. At 1202, at least one copy control watermark is extracted from detector from an audio portion of a content using a copy control information (CCI) watermark, where the at least one copy control watermark indicates that access rights to the content is restricted. At 1204, using an extended payload watermark extractor, at least one extended payload watermark is extracted from the audio portion of the content and extended payload information is generated. For example, the extended payload information can include (a) an extended payload event that represents a detection of an expended payload value from the content that satisfies predefined conditions, and/or (b) an extended payload record that includes one or more extended payload values that contributed to the extended payload event.

At 1206, the extended payload information is communicated to an enhanced response coordinator component of the media handling device for subsequent transmission to one or more databases. At 1208, referral information regarding one or more alternative options or supplements to the enforcement action is received from the one or more databases at the enhanced response coordinator component. At 1210, the referral information are communicated to a referred sale logic component of the media handling device. At 1212, an indication of availability of one or more alternative options or supplements to the content having restricted access rights are presented on a user interface. At 1214, a request indicative of a selection of the one or more presented alternatives or supplements is received. At 1216, the request is communicated to a digital service provider client component of the media handling device for transmission to one or more digital service providers. At 1218, one or more alternatives or supplements are received from the one or more digital service providers.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

For example, one aspect of the disclosed embodiments relates to a computer program product that is embodied on a non-transitory computer readable medium. The computer program product includes program code for carrying out any one or and/or all of the operations of the disclosed embodiments.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and their practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A media handling device, comprising:
an extended payload watermark extractor coupled to an audio input, the audio input providing digital samples representing an audio portion of a content, the extended payload watermark extractor further coupled to an enhanced response coordinator (ERC);
a copy control information (CCI) watermark detector coupled to the audio input, the CCI watermark detector further coupled to a copy management compliance logic component that determines, based on extracted CCI watermark values provided to the copy management compliance logic component, whether or not access rights to the content is restricted;
the ERC coupled to the extended payload extractor to receive extended payload information from the extended payload extractor, the ERC further coupled to a communication component that allows the ERC to communicate with one or more databases;
a referred sale logic component coupled to the ERC to receive referral information from the ERC, the referral information indicative of one or more alternative options associated with the content having restricted access rights; and
a digital service provider (DSP) client component coupled to the referred sale logic to receive a request for at the least one of the one or more alternative options, the request provided by the referred sales logic to the DSP client component, the DSP client component further coupled to the communication component that allows the DSP client to communicate with one or more digital service providers and to receive the at least one of the one or more alternative options.

2. The media handling device of claim 1, further comprising:
a display; and
an output control component that is coupled to the display to control audio or video presentation capabilities of the display.

3. The media handling device of claim 2, wherein the referred sale logic component is coupled to the output control module to enable presentation of the at least one of the one or more alternative options on the display.

4. The media handling device of claim 1, wherein the extended payload information includes an extended payload event and an extended payload record, the extended payload event representing a detection of an expended payload value from the audio portion that satisfies predefined conditions and the extended payload record including a list of one or more extended payload values that contributed to the extended payload event.

5. The media handling device of claim 1, comprising a player control subsection, and a player presentation engine subsection, wherein:
the referred sale logic component and the copy management compliance logic component are implemented as part of the player control subsection, and
the extended payload watermark extractor and the CCI watermark extractor are implemented as part of the player presentation engine subsection.

6. The media handling device of claim 5, wherein the ERC is implemented as part of the player presentation engine subsection.

7. The media handling device of claim 1, wherein the ERC includes an output to control muting of an audio output of the media handling.

8. A system including the media handling device of claim 1, and further comprising the one or more digital service providers (DSPs) and the one or more databases, wherein each of at least one of the one or more DSPs is coupled to the one or more databases to transmit information regarding referred sale activities and inventory to the one or more databases.

9. The system of claim 8, wherein the one or more databases are located at different geographical locations.

10. A method for facilitating usage of a content handling device, the method comprising:
extracting at least one copy control watermark using a copy control information (CCI) watermark detector from an audio portion of a content, the at least one copy control watermark indicating that access rights to the content is restricted;
using an extended payload watermark extractor to extract at least one extended payload watermark from the content and to generate extended payload information;
communicating the extended payload information to an enhanced response coordinator component of the media handling device for subsequent transmission to one or more databases;
receiving from the one or more databases referral information regarding one or more alternative options to the content having restricted access rights at the enhanced response coordinator component;
communicating the referral information to a referred sale logic component of the media handling device;
presenting an indication of availability of the one or more alternative options on a user interface;
receiving a request indicative of a selection of the one or more presented alternative options;
communicating the request to a digital service provider client component of the media handling device for transmission to one or more digital service providers; and
receiving the one or more alternative options from the one or more digital service providers.

11. The method of claim 10, wherein the one or more alternative options allow the user to perform at least one of the following:
buy a movie ticket,
view a different content,
access the content upon purchase of the content,
view one or more advertisements,
view an abbreviated version of the content,
view a modified version of the content with inferior perceptible quality, or
gain access to the content by paying a subscription fee to a service.

12. The method of claim 10, further comprising:
presenting the one or more alternative options using the media handling device.

13. The method of claim 10, wherein the extended payload information includes (a) an extended payload event, the extended payload event representing a detection of an expended payload value from the content that satisfies predefined conditions, and (b) an extended payload record, the extended payload record including one or more extended payload values that contributed to the extended payload event.

14. The method of claim 10, further comprising transmitting information regarding referred sale activities or inventory from the one or more DSPs to the one or more databases.

15. The method of claim 14, wherein the information regarding referred sale activities or inventory includes one or both of:
a product inventory report indicative of available products and services at the one or more DSPs, or
a referral activity report indicative of the referral activities that have occurred at the one or more DSPs during a period of time.

16. The method of claim 10, further comprising performing one of the following:
upon a determination that a customer or a customer device is authorized to access the content, allowing presentation of the content; or
upon a determination that the content is a pirated content, interfering with unauthorized access to the content.

17. The method of claim 16, wherein interfering with unauthorized access to the content includes muting the content's audio.

18. The method of claim 10, wherein a content identifier is transmitted to the one or more databases prior to a determination that an enforcement action is needed to restrict the use of the content.

19. The method of claim 10, further comprising processing a content identifier to identify the content and one or more of a content owner or content rights.

20. A computer program product, embodied on one or more non-transitory computer readable media, the computer program product comprising:
program code for extracting at least one copy control watermark using a copy control information (CCI) watermark detector from an audio portion of a content, the at least one copy control watermark indicating that access rights to the content is restricted;
program code for using an extended payload watermark extractor to extract at least one extended payload watermark from the content and to generate extended payload information;
program code for communicating the extended payload information to an enhanced response coordinator component of the media handling device for subsequent transmission to one or more databases;
program code for receiving from the one or more databases referral information regarding one or more alternative options associated with the content having restricted access rights at the enhanced response coordinator component;
program code for communicating the referral information to a referred sale logic component of the media handling device;
program code for presenting an indication of availability of the one or more alternative options on a user interface;
program code for receiving a request indicative of a selection of the one or more presented alternative options;
program code for communicating the request to a digital service provider client component of the media handling device for transmission to one or more digital service providers; and
program code for receiving the one or more alternative options from the one or more digital service providers.
